(19) United States
(12) Patent Application Publication
(10) Pub. No.: US 2024/0116373 A1
(43) Pub. Date: Apr. 11, 2024

(54) FOUR-IN-ONE DRIVE POWERTRAIN FOR ELECTRIC VEHICLE

(71) Applicant: Zhejiang Xiyan Technology Co., Ltd., Taizhou (CN)

(72) Inventors: Di Shi, Taizhou (CN); Shengjun Lin, Taizhou (CN); Minjiang Wu, Taizhou (CN)

(21) Appl. No.: 18/542,625

(22) Filed: Dec. 16, 2023

(51) Int. Cl. B60L 50/52

(52) U.S. Cl. CPC B60L 50/52; B60K 2001/003; B60L 2220/50

(57) ABSTRACT

The present disclosure provides a power unit, aiming to provide a four-in-one drive powertrain for an electric vehicle. Key points of the technical scheme include a shell body. One side of the shell body is formed with a chamber having a partition structure arranged in a middle part thereof, the partition structure separates the chamber into a control part and a drive part, and the other side of the shell body is provided with a deceleration part and a DC/DC part. The control part includes a containing cavity positioned on a left side of the chamber and integrally formed with the shell body to place a controller. The drive part includes an accommodating cavity positioned on a right side of the chamber and integrally formed with the shell body to install an electric motor.

### TECHNICAL FIELD

The present disclosure relates to a power unit, more particularly to a four-in-one drive powertrain for an electric vehicle.

### BACKGROUND

Power unit is a generic term for systems and accessories essential to guarantee normal operations of electric vehicles.

DC/DCs, controllers, electric motors and gear boxes employed in existing electric vehicles are all commonly known technologies in terms of usage and connection as a drive part. Wires distributed and connected therebetween are too messy and are also troublesome to move. Therefore, a four-in-one drive powertrain for an electric vehicle is needed that can integrate the DC/DC, the controller, the electric motor and the gear box into one piece.

### SUMMARY

In view of the shortcomings of the existing technologies, the present disclosure aims to provide a four-in-one drive powertrain for an electric vehicle.

In order to achieve the above aim, the present disclosure provides a technical scheme as follows. A four-in-one drive powertrain for an electric vehicle includes a shell body. One side of the shell body is formed with a chamber having a partition structure arranged in a middle part thereof, the partition structure separates the chamber into a control part and a drive part, and the other side of the shell body is provided with a deceleration part and a DC/DC part.

The control part includes a containing cavity positioned on a left side of the chamber and integrally formed with the shell body to place a controller.

The drive part includes an accommodating cavity positioned on a right side of the chamber and integrally formed with the shell body to install an electric motor.

The deceleration part includes a gear box in transmission connection with the electric motor inside the accommodating cavity.

The DC/DC part includes a fixing structure arranged on a back surface of the containing cavity, the fixing structure has formed therein a fixing cavity configured to install a DC/DC, and the DC/DC inside the fixing cavity is electrically connected to the controller inside the containing cavity.

The present disclosure is further arranged as follows. The partition structure includes a heat isolation groove formed in one side of a middle part of a back surface of the chamber close to the accommodating cavity, the heat isolation groove has provided therein a plurality of air deflectors that are evenly distributed along a length direction of the shell body, and the air deflectors extend to the back surface of the containing cavity, whereby the heat isolation groove and the air deflectors form a heat isolation structure.

The present disclosure is further arranged as follows. Connecting transition surfaces between an inner surface of the containing cavity, a back surface of the heat isolation groove and an inner surface of the accommodating cavity and connecting transition surfaces between the back surface of the containing cavity, an inner surface of the heat isolation groove and a back surface of the accommodating cavity are all smooth step surfaces.

The present disclosure is further arranged as follows. The shell body is evenly provided with a plurality of heat radiation teeth on a circumferential side of an outer wall of the accommodating cavity.

The present disclosure is further arranged as follows. The back surface of the heat isolation groove is provided with a separating frame positioned inside the chamber and configured to separate wires.

The present disclosure is further arranged as follows. The back surface of the heat isolation groove forms a height inside the chamber that is half a height of the containing cavity.

The present disclosure is further arranged as follows. The separating frame has a top surface lower than or as high as a top surface of the chamber.

The present disclosure is further arranged as follows. The back surface of the heat isolation groove is provided with a plurality of triangular rib plates on one side close to the accommodating cavity.

The present disclosure is further arranged as follows. A central length of the heat isolation groove and a total length of the shell body are in a ratio of 6 to 7.

The present disclosure has the following benefits.
1. Compared to the existing technologies, the four-in-one drive powertrain for the electric vehicle according to the present disclosure has the DC/DC, the controller, the electric motor and the gear box arranged on the shell body, whereby the four-in-one drive powertrain for the electric vehicle in the present application avoids the defects in the existing technologies that wires distributed and connected therebetween are too messy and are also troublesome to move. According to the present disclosure, the distribution is orderly, there will be no lead wire exposed out after each part is connected, the security is improved, and it is convenient to move and install the four-in-one drive powertrain.
2. In the four-in-one drive powertrain for the electric vehicle of the present disclosure, the shell body is evenly provided with a plurality of heat radiation teeth on the circumferential side of the outer wall of the accommodating cavity so that the heat generated when the electric motor operates can be dissipated in time by means of the heat radiation teeth, thereby preventing the electric motor being overheated to impact the working efficiency of the four-in-one drive powertrain for the electric vehicle and prolonging the service life of the electric motor.
3. In the present disclosure, the partition structure includes the heat isolation groove formed in one side of the middle part of the back surface of the chamber close to the accommodating cavity. The heat isolation groove has provided therein a plurality of air deflectors that are evenly distributed along the length direction of the shell body, and the air deflectors extend to the back surface of the containing cavity, whereby the heat isolation groove and the air deflectors form a heat isolation structure, which can guide air to the control part, so that the heat inside the containing cavity can be dissipated by means of the air deflectors. Furthermore, the air deflectors are further configured to enhance the overall strength of the shell body.
4. The present disclosure is simple and reasonable in structure, easy to manufacture and avoids the defects in existing technologies, hence is suitable for promotion, implementation and application.

### BRIEF DESCRIPTION OF THE DRAWINGS

FIG. 1 is a structure diagram of one side of a four-in-one drive powertrain for an electric vehicle according to the present disclosure.

FIG. 2 is a partial structure diagram of a four-in-one drive powertrain for an electric vehicle according to the present disclosure.

FIG. 3 is a structure diagram of another side of a four-in-one drive powertrain for an electric vehicle according to the present disclosure.

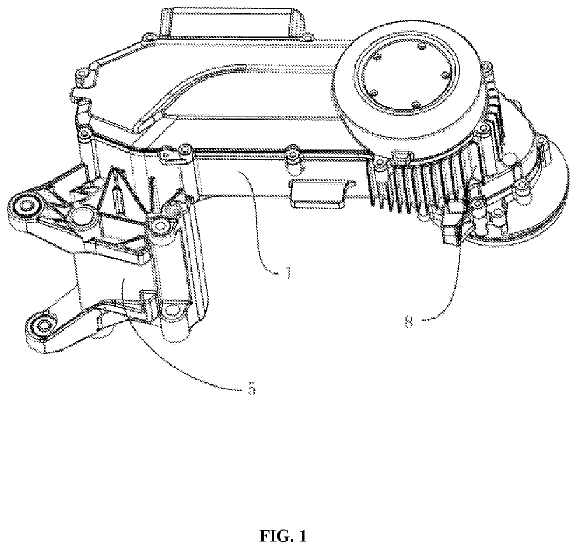

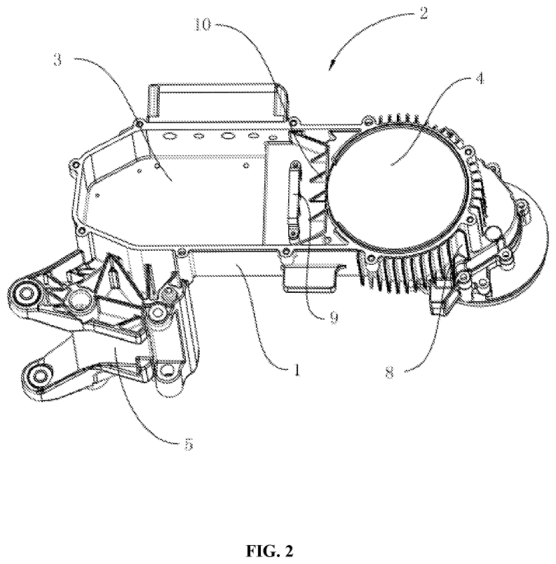

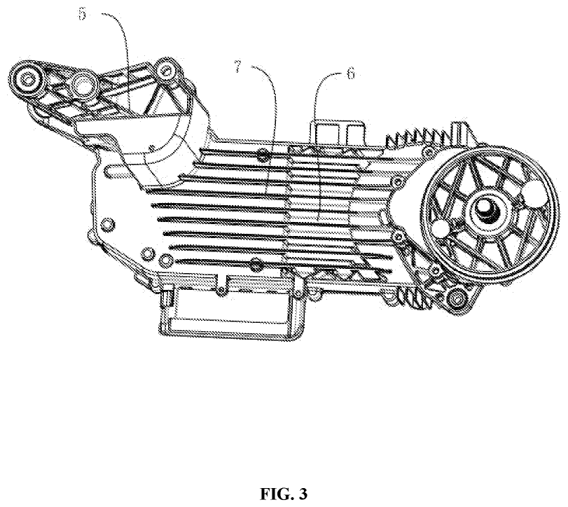

Designators on FIG. 1 to FIG. 3 are as described below: 1, a shell body; 2, a chamber; 3, a containing cavity; 4, an accommodating cavity; 5, a fixing structure; 6, a heat isolation groove; 7, an air deflector; 8, a heat radiation tooth; 9, a separating frame; and 10, a triangular rib plate.

### DETAILED DESCRIPTION OF THE EMBODIMENTS

Embodiments of the four-in-one drive powertrain for the electric vehicle of the present disclosure are described below in further detail by reference to FIG. 1 to FIG. 3.

To ease illustration, relative spatial terms such as “above”, “below”, “left”, “right”, etc. are employed in the embodiments to illustrate the relationship of one element or feature shown on the drawings relative to another element or feature. It should be understood that besides the orientation shown on the drawings, the spatial terms are intended to cover different orientations of a device in usage or operation. For example, if a device on the drawings is inverted, the element which is described as positioned “below” other elements or features will be positioned “above” the other elements or features. As a result, the exemplary term “below” may include both orientations of above and below. The device can be positioned by other ways (rotating 90 degrees or being positioned in other orientations), and the relative spatial terms used herein may be explained accordingly.

Furthermore, relationship terms such as “first”, “second”, etc. are merely employed to distinguish one component from another component having the same name, rather than necessarily requiring or implying that there is any such actual relationship or sequence between those components.

A four-in-one drive powertrain for an electric vehicle shown in FIG. 1 to FIG. 3 includes shell body 1. One side of the shell body 1 is formed with a chamber 2 having a partition structure arranged in a middle part thereof, the partition structure separates the chamber 2 into a control part and a drive part, the other side of the shell body 1 is provided with a deceleration part and a DC/DC part.

The control part includes a containing cavity 3 positioned on a left side of the chamber 2 and integrally formed with the shell body 1 to place a controller.

The drive part includes an accommodating cavity 4 positioned on a right side of the chamber 2 and integrally formed with the shell body 1 to install an electric motor.

The deceleration part includes a gear box in transmission connection with the electric motor inside the accommodating cavity 4.

The DC/DC part includes a fixing structure 5 arranged on a back surface of the containing cavity 3, the fixing structure 5 has formed therein a fixing cavity configured to install a DC/DC, and the DC/DC inside the fixing cavity is electrically connected to the controller inside the containing cavity 3.

The shell body 1 is provided with a protective cover fitting with a front surface thereof and configured to cover the chamber 2, for the purpose of preventing dust or impurities entering inside the shell body 1 to impact operations of the controller inside the containing cavity 3 and the electric motor inside the accommodating cavity 4, thus prolonging the service life.

The partition structure includes a heat isolation groove 6 formed in one side of a middle part of a back surface of the chamber 2 close to the accommodating cavity 4. The heat isolation groove 6 has provided therein a plurality of air deflectors 7 that are evenly distributed along a length direction of the shell body 1, and the air deflectors 7 extend to the back surface of the containing cavity 3, whereby the heat isolation groove 6 and the air deflectors 7 form a heat isolation structure, which can play a function of isolating the accommodating cavity 4 from the containing cavity 3, preventing the heat generated by the electric motor in the accommodating cavity 4 being transferred into the containing cavity 3 to impact the usage of the controller and hence effectively prolonging the service life of the controller. In addition, the air deflectors 7 guide air to the control part, so that the heat inside the containing cavity 3 can be dissipated by means of the air deflectors 7. Furthermore, the air deflectors 7 are further configured to enhance the overall strength of the shell body 1.

Connecting transition surfaces between an inner surface of the containing cavity 3, a back surface of the heat isolation groove 6 and an inner surface of the accommodating cavity 4 and connecting transition surfaces between the back surface of the containing cavity 3, an inner surface of the heat isolation groove 6 and a back surface of the accommodating cavity 4 are all smooth step surfaces.

The shell body 1 is evenly provided with a plurality of heat radiation teeth 8 on a circumferential side of an outer wall of the accommodating cavity 4. In the four-in-one drive powertrain for the electric vehicle of the present disclosure, the shell body 1 is evenly provided with a plurality of heat radiation teeth 8 on the circumferential side of the outer wall of the accommodating cavity 4 so that the heat generated when the electric motor operates can be dissipated in time by means of the heat radiation teeth 8, thereby preventing the electric motor being overheated to impact the working efficiency of the four-in-one drive powertrain for the electric vehicle and prolonging the service life of the electric motor.

The back surface of the heat isolation groove 6 is provided with a separating frame 9 positioned inside the chamber 2 and configured to separate wires. The separating frame 9 is configured to orderly separate lead wires connected between the controller inside the containing cavity 3 and the electric motor inside the accommodating cavity 4, preventing the lead wires being messily placed and even being entangled to generate heat to result in safety hazards. The containing cavity 3 has formed in an internal rear side thereof a plurality of heat radiation holes penetrating through the shell body 1, which can further enhance the function of heat radiation and discharge out the heat inside the containing cavity 3.

The back surface of the heat isolation groove 6 forms a height inside the chamber 2 that is half a height of the containing cavity 3, being beneficial for the connection of lead wires between the controller and the electric motor.

The separating frame 9 has a top surface lower than or as high as a top surface of the chamber 2. In the case that the top surface of the separating frame 9 is higher than the top surface of the chamber 2, it is easy to occur that the protective cover is unable to cover the shell body 1 and thus cannot prevent dust entering inside the shell body 1. Therefore, it is preferable that the separating frame 9 has the top surface lower than or as high as the top surface of the chamber 2.

The back surface of the heat isolation groove 6 is provided with a plurality of triangular rib plates 10 on one side close to the accommodating cavity 4. The triangular rib plates play a function of supporting and simultaneously can also play a function of heat radiation.

A central length of the heat isolation groove 6 and a total length of the shell body 1 are in a ratio of 6 to 7, whereby the heat isolation groove 6 can achieve a best heat isolation effect. If the ratio is less than 6, the central length of the heat isolation groove 6 is too long. Although a better heat isolation effect can be achieved, the length of the containing cavity 3 would be reduced, and the space for placing the controller would be reduced accordingly. The controller might be unable to be placed inside the containing cavity 3 if slightly bigger. If the ratio is greater than 7, the central length of the heat isolation groove 6 is too short. Although the length of the containing cavity 3 can become greater and it can be easier to place the controller, the heat isolation effect would be greatly reduced between the accommodating cavity 4 and the containing cavity 3. Even heat accumulation might be caused therebetween to impact work. Therefore, it is preferable that the central length of the heat isolation groove 6 and the total length of the shell body 1 are in a ratio of 6 to 7.

Compared to the existing technologies, the four-in-one drive powertrain for the electric vehicle according to the present disclosure has the DC/DC, the controller, the electric motor and the gear box arranged on the shell body 1, whereby the four-in-one drive powertrain for the electric vehicle in the present application avoids the defects in the existing technologies that wires distributed and connected therebetween are too messy and are also troublesome to move. According to the present disclosure, the distribution is orderly, there will be no lead wire exposed out after each part is connected, the security is improved, and it is convenient to move and install the four-in-one drive powertrain. The present disclosure is simple and reasonable in structure, easy to manufacture and avoids the defects in existing technologies, hence is suitable for promotion, implementation and application.

The above are preferred embodiments of the present disclosure merely and the present disclosure is not limited thereto. General changes and substitutions made within the scope of the technical scheme of the present disclosure by those skills in the art are all intended to be included within the scope of protection of the present disclosure.

What is claimed is:

1. A four-in-one drive powertrain for an electric vehicle, comprising a shell body (1), wherein one side of the shell body (1) is formed with a chamber (2) having a partition structure arranged in a middle part thereof, the partition structure separates the chamber (2) into a control part and a drive part, the other side of the shell body (1) is provided with a deceleration part and a DC/DC part;
the control part comprises a containing cavity (3) positioned on a left side of the chamber (2) and integrally formed with the shell body (1) to place a controller;
the drive part comprises an accommodating cavity (4) positioned on a right side of the chamber (2) and integrally formed with the shell body (1) to install an electric motor;
the deceleration part comprises a gear box in transmission connection with the electric motor inside the accommodating cavity (4); and
the DC/DC part comprises a fixing structure (5) arranged on a back surface of the containing cavity (3), the fixing structure (5) has formed therein a fixing cavity configured to install a DC/DC, and the DC/DC inside the fixing cavity is electrically connected to the controller inside the containing cavity (3).

2. The four-in-one drive powertrain for the electric vehicle according to claim 1, wherein the partition structure comprises a heat isolation groove (6) formed in one side of a middle part of a back surface of the chamber (2) close to the accommodating cavity (4), the heat isolation groove (6) has provided therein a plurality of air deflectors (7) that are evenly distributed along a length direction of the shell body (1), and the air deflectors (7) extend to the back surface of the containing cavity (3), whereby the heat isolation groove (6) and the air deflectors (7) form a heat isolation structure.

3. The four-in-one drive powertrain for the electric vehicle according to claim 1, wherein connecting transition surfaces between an inner surface of the containing cavity (3), a back surface of the heat isolation groove (6) and an inner surface of the accommodating cavity (4) and connecting transition surfaces between the back surface of the containing cavity (3), an inner surface of the heat isolation groove (6) and a back surface of the accommodating cavity (4) are all smooth step surfaces.

4. The four-in-one drive powertrain for the electric vehicle according to claim 2, wherein connecting transition surfaces between an inner surface of the containing cavity (3), a back surface of the heat isolation groove (6) and an inner surface of the accommodating cavity (4) and connecting transition surfaces between the back surface of the containing cavity (3), an inner surface of the heat isolation groove (6) and a back surface of the accommodating cavity (4) are all smooth step surfaces.

5. The four-in-one drive powertrain for the electric vehicle according to claim 1, wherein the shell body (1) is evenly provided with a plurality of heat radiation teeth (8) on a circumferential side of an outer wall of the accommodating cavity (4).

6. The four-in-one drive powertrain for the electric vehicle according to claim 2, wherein the back surface of the heat isolation groove (6) is provided with a separating frame (9) positioned inside the chamber (2) and configured to separate wires.

7. The four-in-one drive powertrain for the electric vehicle according to claim 2, wherein the back surface of the heat isolation groove (6) forms a height inside the chamber (2) that is half a height of the containing cavity (3).

8. The four-in-one drive powertrain for the electric vehicle according to claim 7, wherein the separating frame (9) has a top surface lower than or as high as a top surface of the chamber (2).

9. The four-in-one drive powertrain for the electric vehicle according to claim 2, wherein the back surface of the heat isolation groove (6) is provided with a plurality of triangular rib plates (10) on one side close to the accommodating cavity (4).

10. The four-in-one drive powertrain for the electric vehicle according to claim 2, wherein a central length of the heat isolation groove (6) and a total length of the shell body (1) are in a ratio of 6 to 7.
